(19) United States
(12) Patent Application Publication
(10) Pub. No.: US 2010/0111029 A1
(43) Pub. Date: May 6, 2010

(54) Fast feedback contention-based data transmission in wireless communications systems

(75) Inventors: Chao-Chin Chou, Taipei City (TW); Yih-Shen Chen, Hsinchu City (TW); I-Kang Fu, Taipei City (TW)

Correspondence Address: IMPERIUM PATENT WORKS, P.O. BOX 607, Pleasanton, CA, 94566, US

(73) Assignee: MEDIATEK INC.

(21) Appl. No.: 12/655,835

(22) Filed: Jan. 8, 2010

Related U.S. Application Data
(63) Continuation-in-part of application No. 12/387,380, filed on Apr. 30, 2009.
(60) Provisional application No. 61/050,280, filed on May 5, 2008.

(51) Int. Cl. H04W 72/04

(52) U.S. Cl. 370/329

(57) ABSTRACT

A fast feedback mechanism is provided in a contention-based data transmission procedure. A Subscriber Station (SS) transmits a data burst to a base station (BS) using a selected data grant in a previous uplink (UL) frame. The SS also starts a timer associated with the data transmission. The data grant is selected from a plurality of data grants granted by the BS for contention-based access. In response to all received data grants in the previous UL frame, the BS broadcasts an acknowledgement (ACK) in a subsequent downlink (DL) frame. The ACK comprises a reception status message that indicates the detection result of the data grants. With the novel fast feedback mechanism, when data collision occurs, upon receiving the detection result indicator, the SS proceeds by retransmitting data without continuing wait for the entire timeout period. As a result, the total latency due to the data collision is reduced.

### CROSS REFERENCE TO RELATED APPLICATIONS

This application is a continuation-in-part of, and claims priority under 35 U.S.C. §120 from nonprovisional U.S. patent application Ser. No. 12/387,380, entitled “Fast Feedback Contention-Based Ranging Procedure in Wireless Communications Systems,” filed on Apr. 30, 2009, the subject matter of which is incorporated herein by reference. Application Ser. No. 12/387,380, in turn, claims priority under 35 U.S.C. §119 from U.S. Provisional Application No. 61/050,280, entitled “Collision Detection and Fast Feedback for Contention-based OFDMA Ranging,” filed on May 5, 2008, the subject matter of which is incorporated herein by reference.

### TECHNICAL FIELD

The disclosed embodiments relate generally to wireless network communications, and, more particularly, to contention-based ranging procedure and data transmission.

### BACKGROUND

FIG. 1 (Prior Art) illustrates a contention-based CDMA ranging procedure. As illustrated in FIG. 1, in a CDMA ranging procedure, each Subscriber Stations (SS) randomly selects a CDMA ranging code from a predefined code pool, and transmits the ranging code to a Base Station (BS) via a randomly selected ranging slot from a limited number of ranging slots on a shared ranging channel provided by the BS. In the example of FIG. 1, SS1 transmits a CDMA Code sequence, indexed by CDMA Code1, on ranging slot 1, SS2 transmits a CDMA Code sequence, indexed by CDMA Code2, on ranging slot 3, and SS3 transmits a CDMA Code sequence, indexed by CDMA Code3, on ranging slot 11.

FIG. 2 (Prior Art) is a conventional message sequence diagram corresponding to the CDMA ranging procedure in FIG. 1. As illustrated in FIG. 2, after successful detection of the ranging codes, Base Station BS1 responses with ranging response (RNG_RSP) and uplink (UL) allocation information (CDMA Allocation IE). However, when many SSs attempt to initiate ranging procedures simultaneously, the SSs have to contend for access to the shared ranging channel. As a result, a ranging collision may occur in a wireless communications system employ conventional CDMA ranging.

FIG. 3 (Prior Art) illustrates an example of a CDMA ranging collision. Subscriber Stations SS1, SS2 and SS3 transmit different ranging codes on the same ranging slot simultaneously. The ranging codes collide and are thus not decodable by the Base Station BS1. As a result, BS1 will not transmit a successful ranging response back to the SSs. In the example of FIG. 3, after sending out an initial ranging code, each SS starts a predefined timer and waits for a ranging response from BS1 until the timer expires. After the timer expires, the SS will wait for a backoff window before retransmitting the ranging code for a next round of contention. Thus, the overall time delay caused by the ranging collision can be calculated based on the following formula:

T_{delay}=TₜᵢₘₑᵣT_{backoff}·T_{frame}_{_{—}}_{length}

where T_{delay} is the total delay time, Tₜᵢₘₑᵣ is the timeout value, T_{backoff} is the backoff time, and T_{frame}_{_{—}}_{length} is the length of a frame.

FIG. 4 illustrates another example of a CDMA ranging failure. Subscriber station SS1 transmits an initial ranging code to the Base Station BS1. The ranging code is successfully received and decoded by BS1. Uplink (UL) resource, however, cannot be granted by BS1 due to insufficient bandwidth. Without receiving a successful UL grant, SS1 waits for timer expiration plus a backoff window, and then retransmits the ranging code for a next round of contention. The overall time delay can be calculated based on the following formula:

T_{delay}=TₜᵢₘₑᵣT_{backoff}·T_{frame}_{_{—}}_{length}

where T_{delay} is the total delay time, Tₜᵢₘₑᵣ is the timeout value, T_{backoff} is the backoff time, and T_{frame}_{_{—}}_{length} is the length of a frame.

FIG. 5 illustrates a third example of a CDMA ranging procedure. In the example of FIG. 5, two Subscriber Stations SS1 and SS2 transmit the same ranging code on the same ranging slot. Base Station BS1 successfully decodes the ranging code and replies with a ranging response (RNG_RSP with ranging status =success) and a CDMA Allocation IE to both SS1 and SS2. When SS1 and SS2 receive the response from BS1, each SS sends a subsequent ranging request message simultaneously. As a result, the ranging request messages collide and the SSs no longer receive any response from BS1 until expiration of timer. The overall time delay can be calculated by the formula below:

E[T_{delay}]=1.5Tₜᵢₘₑᵣ+(T_{backoff}+1)·T_{frame}_{_{—}}_{length}

where T_{delay} is the total delay time, Tₜᵢₘₑᵣ is the timeout value, T_{backoff} is the backoff time, and T_{frame}_{_{—}}_{length} is the length of a frame.

FIG. 6 illustrates a diagram of the probability (P_{collision}) of at least two users select the same code and the same slot. In the example of FIG. 6, the total number of users is thirty, the number of available ranging codes is sixty-four, and the number of available ranging slots is thirty. As the number of users increases, P_{collision} also increases. When the number of user approaches thirty, P_{collision} is very close to one. P_{collision} can be expressed by the formula below:

$${P}_{collision} = 1 - \frac{{\prod }_{i = 0}^{Nu - 1} ( NcNs - i )}{{( NcNs )}^{Nu}}$$

$${P}_{collision} = 1 - \frac{{\prod }_{i = 0}^{Nu - 1} ( NcNs - i )}{{( NcNs )}^{Nu}}$$

where Nu is the total number of users, Nc is the number of available ranging codes, and Ns is the number of available ranging slots.

If a large amount of collisions are caused by the contention access, then it becomes difficult for any of the SSs to complete its ranging procedure. Therefore, excessive time is needed for all the SSs to restart their ranging procedures, and much bandwidth on the shared ranging channel is wasted. The total latency introduced by ranging collision can be expressed by:

$${T}_{total\_delay} = {\sum }_{i = 1}^{R} {T}_{{delay}_{i}}$$

where T_{delay} is the delay time for each SS, which depends on Tₜᵢₘₑᵣ, T_{backoff}, and T_{frame}_{_{—}}_{length}. In an IEEE 802.16e system, Tₜᵢₘₑᵣ ranges from 60 ms to 200 ms, T_{backoff} ranges from 2° to 2¹⁵ frames and T_{frame}_{_{—}}_{length} is equal to 5 ms. Thus, it is possibly to take more than one second to complete the ranging procedure.

In a next generation 4G system, the maximum interruption time is 30 ms for intra-frequency handover and 100 ms for inter-frequency handover. Therefore, the latency introduced by ranging collision needs to be reduced in order to meet the requirements of 4G systems. Various efforts have been made to design a more efficient and faster ranging procedure.

LG Electronics proposed a differentiated random access scheme for contention-based bandwidth request ranging procedure. As shown in FIG. 7A, different timeout values are applied based on the priority of each bandwidth request (BR) indicator. To communicate the different priority and timeout values, a Base Station may broadcast a map of priority and timeout value to all the Subscriber Stations. For example, real-time service (rtPS) and extended real-time service (ertPS) are both high priority services having a shorter timeout value of 50 ms, while non real-time service (nrtPS) and best effort (BE) are low priority services having a longer timeout value of 100 ms.

FIG. 7B is a message sequence diagram of a differentiated bandwidth request ranging procedure proposed by LG Electronics. As illustrated in FIG. 7B, high priority services such as rtPS have a shorter timeout and thus a shorter delay while low priority services such as nrtPS have a longer timeout and thus a longer delay. During this ranging procedure, however, the SS still waits for timer expiration while contention resolution remains unhandled. Furthermore, such differentiated random access scheme is not applicable to random access channels of equal opportunity such as the ranging channel for initial ranging.

### SUMMARY

A fast feedback mechanism is provided in a contention-based ranging procedure. A Subscriber Station (SS) initializes a ranging procedure by sending a ranging code on a selected ranging opportunity for resource access to a Base Station (BS) on a shared ranging channel in a previous uplink frame. The SS also starts a timer associated with the ranging code. In response to all received ranging opportunities, the BS broadcasts an acknowledgement (ACK) in a subsequent downlink frame. The ACK comprises a reception status message that indicates the decoding status of the ranging opportunities. With the novel fast feedback mechanism, when ranging collision or failure occurs, upon receiving the reception status report, the SS will proceed with the next round of contention without continuing wait for the entire timeout period. As a result, the total latency due to the ranging collision or failure is reduced.

In one embodiment, the SS initiates an initial or periodic ranging procedure by transmitting an initial ranging code or a periodic ranging code to the BS. The BS broadcasts an ACK followed by a ranging response if the ranging code is successfully decoded and an uplink grant for ranging request message. In one example, the ranging response and the UL grant is embedded within the ACK to reduce overhead. When the SS later transmits a ranging request message, the BS optionally transmits a negative acknowledgement (NACK) message if the ranging request message is corrupted.

In another embodiment, the SS initiates a bandwidth request (BR) ranging procedure by transmitting a BR ranging code to the BS. The BS broadcasts an ACK followed by an uplink grant for BR message if the BR ranging code is successfully decoded. In one example, the UL grant is embedded within the ACK to reduce overhead. When the SS later transmits a BR message, the BS optionally transmits a NACK if the BR message is corrupted. Otherwise, the BS transmits an UL grant for data and the SS starts transmitting data using scheduled UL resource.

The broadcasted ACK may be in the format of a bitmap, a type/length/value (TLV) triple, or a standalone MAC management message. In one example, the ACK is in a bitmap format comprising a plurality of bits, and each bit indicates a reception status of each ranging opportunity. In another example, the ACK comprises additional information such as a decodable ranging code that corresponds to each ranging opportunity, a ranging response, and/or a CDMA Allocation IE.

In yet another embodiment, a fast feedback mechanism is provided in a contention-based data transmission procedure. A Subscriber Station (SS) transmits a data burst to a base station (BS) using a selected data grant in a previous uplink (UL) frame. The SS also starts a timer associated with the data transmission. The data grant is selected from a plurality of data grants granted by the BS for contention-based access. In response to all received data grants in the previous UL frame, the BS broadcasts an acknowledgement (ACK) or a reception status message in a subsequent downlink (DL) frame. The ACK comprises a detection result indicator that indicates the detection results of each of the data grants.

In one example, the detection result indicator for contention-based data transmission is piggybacked in a MAC PDU to improve efficiency. In another example, the detection result indicator has a plurality of bits, and a reception status of each data grant is indicated by one of the plurality of bits that corresponds to the data grant. In yet another example, the detection result indicator further advertises station IDs of which the transmitted data is successfully decoded. With the novel fast feedback mechanism, when data collision occurs, upon receiving the detection result indicator, the SSs proceed by retransmitting data without continuing wait for the entire timeout period. As a result, the total latency due to the data collision is reduced.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 (Prior Art) and FIG. 2 (Prior Art) illustrate a conventional contention-based CDMA ranging procedure.

FIGS. 3-5 (Prior Art) illustrate examples of a contention-based CDMA ranging procedure.

FIG. 6 (Prior Art) is a diagram of the probability of at least two users select the same code and the same slot for ranging.

FIG. 7A (Prior Art) illustrates a differentiated random access scheme with different timeout values.

FIG. 7B (Prior Art) illustrates a differentiated bandwidth request ranging procedure.

FIG. 8 illustrates a high-level diagram of a fast feedback contention-based CDMA ranging in accordance with a novel aspect.

FIG. 9 is a flow chart of a method of a fast feedback contention-based CDMA ranging procedure in accordance with a novel aspect.

FIG. 10 is a message sequence chart of an initial or periodic ranging procedure with fast feedback in accordance with one novel aspect.

FIG. 11 illustrates a fast feedback mechanism for a failed detection of ranging code in accordance with the present invention.

FIG. 12 illustrates a fast feedback mechanism for a detection of collision of ranging request messages in accordance with the present invention.

FIG. 13 illustrates a more efficient fast feedback mechanism through piggybacking a ranging response in a detection result indicator in accordance with the present invention.

FIG. 14 is a message sequence chart of a bandwidth request ranging procedure with fast feedback in accordance with one novel aspect.

FIG. 15 illustrates a fast feedback mechanism for a failed detection of a bandwidth request indicator in accordance with the present invention.

FIG. 16 illustrates a more efficient fast feedback mechanism through piggybacking an uplink grant in a detection result indicator in accordance with the present invention.

FIG. 17 illustrates a quick access bandwidth request ranging procedure with fast feedback in accordance with one novel aspect.

FIG. 18 illustrates a more efficient fast feedback bandwidth ranging procedure in accordance with a preferred embodiment of the present invention.

FIG. 19 illustrates a quick access bandwidth ranging procedure with fast feedback while a BW-REQ message is not decodable in accordance with a preferred embodiment of the present invention.

FIG. 20 illustrates a fast feedback bandwidth request ranging procedure with different timers in accordance with a preferred embodiment of the present invention.

FIG. 21 illustrates a detection result indicator in the form of a bitmap in accordance with a preferred embodiment of the present invention.

FIG. 22 illustrates another format of a detection result indicator in accordance with a preferred embodiment of the present invention.

FIG. 23 illustrates a fast feedback contention-based data transmission procedure in accordance with a preferred embodiment of the present invention.

FIG. 24 illustrates a detection result indicator piggybacked in a MAC PDU in accordance with one embodiment of the present invention.

FIG. 25 illustrates a detection result indicator for data in the form of a bitmap in accordance with a preferred embodiment of the present invention.

FIG. 26 illustrates another format of a detection result indicator for data in accordance with one embodiment of the present invention.

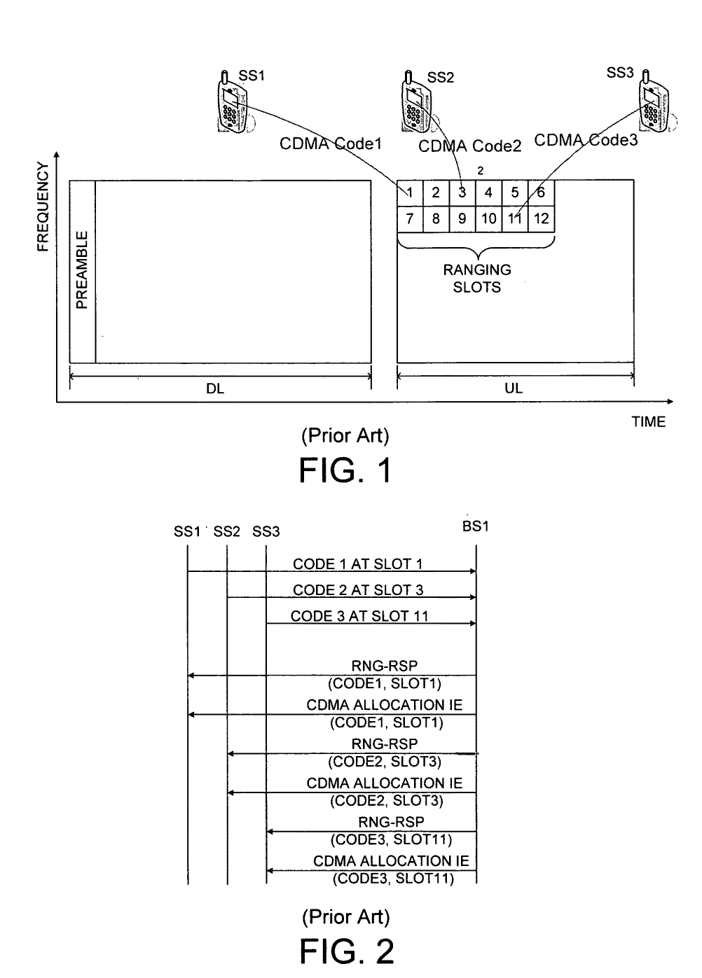

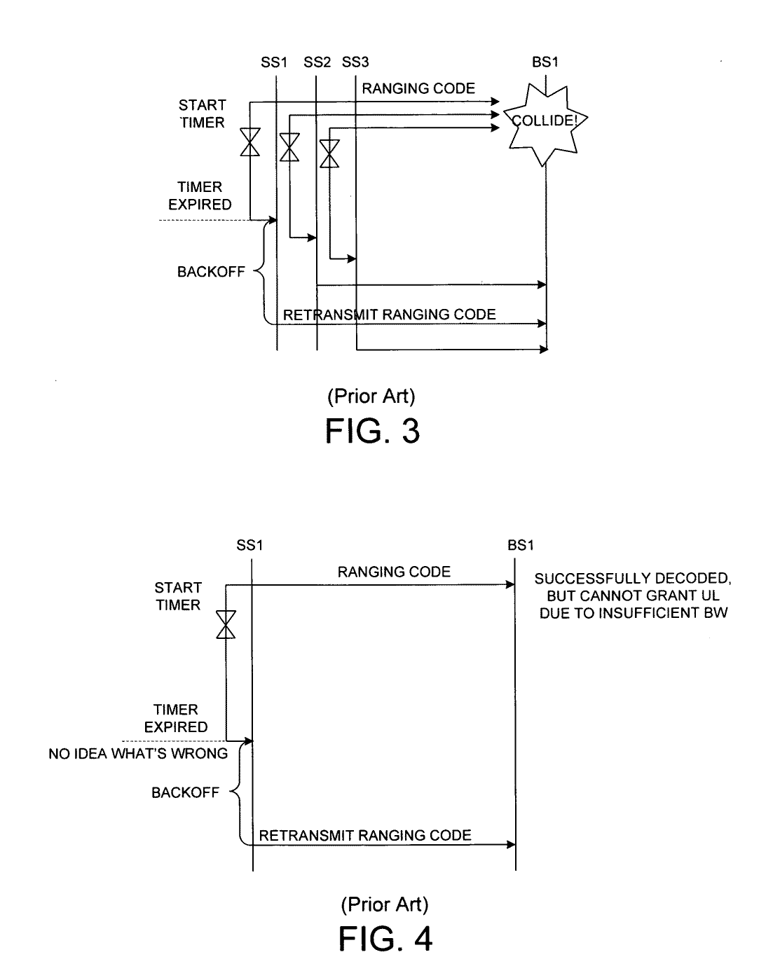

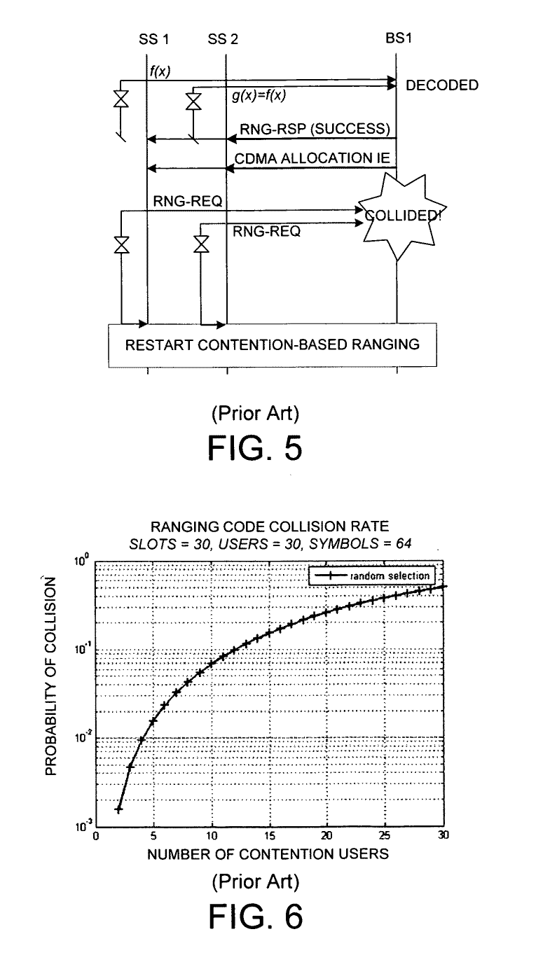

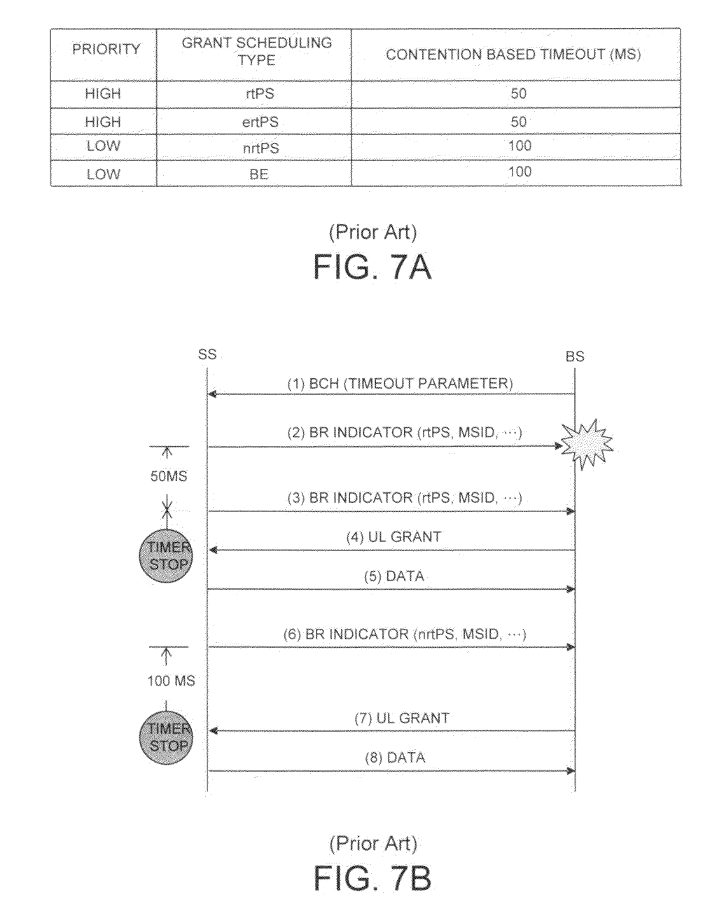

### DETAILED DESCRIPTION

Reference will now be made in detail to some embodiments of the invention, examples of which are illustrated in the accompanying drawings.

FIG. 8 illustrates a high-level diagram of a contention-based Code Division Multiple Access (CDMA) ranging with fast feedback in accordance with a novel aspect. Contention-based CDMA ranging is used in IEEE 802.16 wireless communications systems (i.e., wireless communications system 11), where a Subscriber Station (SS) transmits a ranging code to a Base Station (BS) on a shared ranging channel for various purposes. In the example of FIG. 8, each of the SSs (SS1 to SS6) initiates a ranging procedure by transmitting a randomly selected ranging code on a randomly selected ranging opportunity in a previous uplink frame (UL i), while the BS transmits an acknowledgement (ACK) or a reception status report in a subsequent downlink frame (DL i+1) in response to all ranging opportunities received in the previous uplink frame (UL i). A ranging opportunity comprises either one or multiple ranging slots.

If the ranging codes are successfully decoded by the BS, then the BS responds with a ranging response (RNG-RSP) and/or an uplink (UL) grant. Because the BS cannot tell which SS sent the CDMA ranging code, the BS broadcasts the RNG-RSP and/or UL grant that contains the ranging code attributes it receives. The target of the RNG_RSP and/or UL grant is identified by the code attributes, including ranging code index and the position of the ranging opportunity used to transmit the ranging code including a frame number, a time symbol reference and a sub-channel reference.

When many SSs attempt to initiate ranging procedures simultaneously, the SSs have to contend for access to the shared ranging channel. Ranging collision or failure may occur in several scenarios. As illustrated in FIG. 8, in one example, when two users transmit identical ranging code on the same ranging slot (i.e., SS1-SS2 on slot #3), the ranging code may still be decodable but the users are undistinguishable. This is so-called capture effect. In another example, when too many ranging codes are conveyed by a single ranging slot (i.e., SS3-SS6 on slot #4), the ranging codes may not be decodable due to low SNR caused by noise spreading or frequency-selective fading in the multi-carrier environment. Typically, such ranging collision or failure would introduce latency because the SSs have to retransmit the ranging codes for next ground of contention. Such latency, however, is reduced by employing a novel fast feedback scheme where the BS broadcasts an ACK or a reception status report back to each SS immediately after the detection of the ranging collision or failure.

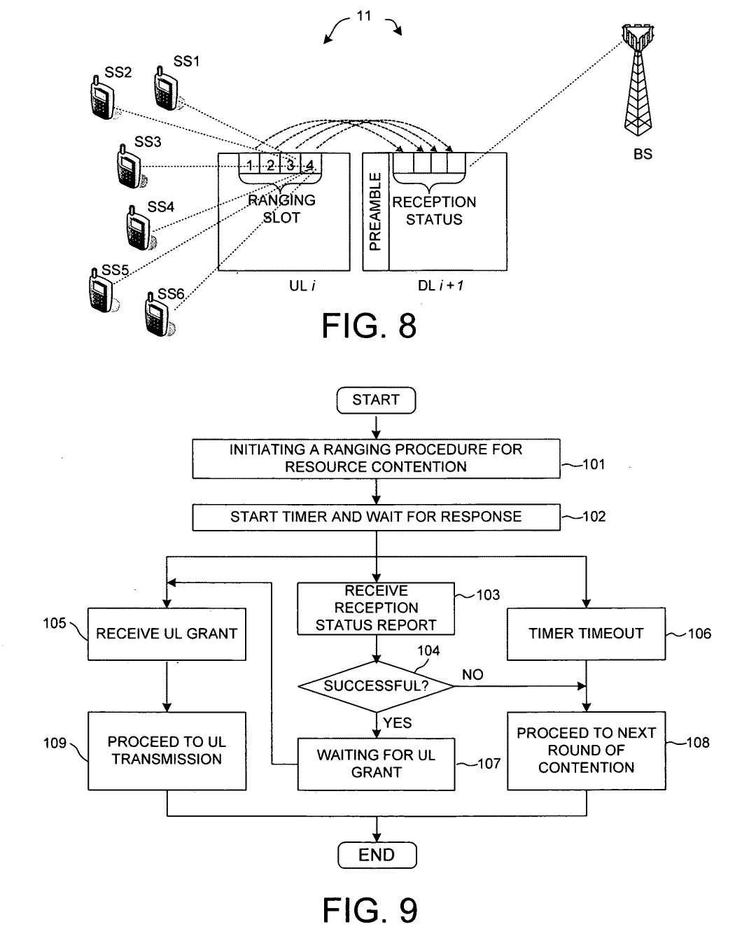

FIG. 9 is a flow chart of a method of fast feedback contention-based CDMA ranging procedure in accordance with a novel aspect. In step 101, a Subscriber Station (SS) initializes a ranging procedure by sending a request to a Base Station (BS) for ranging opportunities. In step 102, the SS starts a pre-defined timer and then begins to wait for a response from the BS. In step 103, the SS receives a reception status report for the requested ranging opportunities from the BS. In step 104, the SS determines whether the decoding of its request is successful based on the received status report. If the request is not successfully decoded, then the SS will continue with step 108 to proceed with the next round of contention; otherwise, it will go on with step 107 to wait for uplink (UL) grant. In step 105, the SS receives a UL grant from the BS, and then proceeds with the UL transmission in step 109. If the SS has not gotten any response from the BS until the pre-defined timer is expired (step 106), then it will continue with step 108 for the next round of contention.

In one novel aspect, a fast feedback mechanism is provided to reduce latency caused by possible ranging collision or failure. Typically, after initiating a ranging procedure, each SS starts a predefined timer and waits for a response or UL grant from the BS until the timer expires. With the novel fast feedback mechanism, however, when ranging collision or failure occurs, upon receiving the ACK or reception status report in step 103, the SS will continue with step 108 to proceed with the next round of contention without continuing to wait for the entire timeout period. As a result, the total latency due to the ranging collision or failure is reduced.

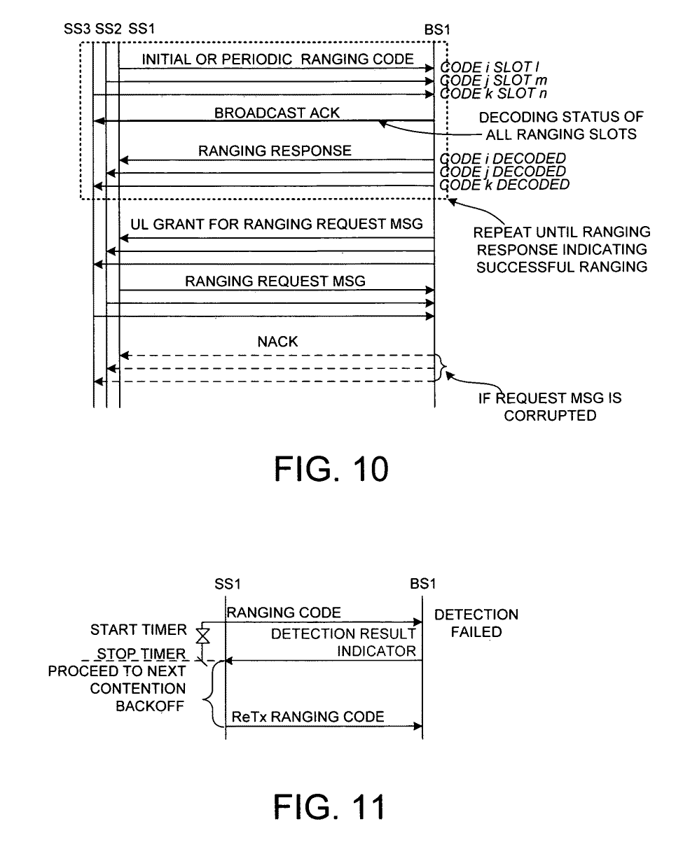

Ranging procedures are categorized into initial ranging, periodic ranging, and bandwidth request ranging. FIG. 10 illustrates a message sequence chart of an initial or periodic ranging procedure in accordance with one novel aspect. In the example of FIG. 10, there are three contention users (SS1, SS2, and SS3) and one base station BS1. Each SS first transmits a randomly selected initial or periodic ranging code to BS1 using a randomly selected ranging slot in a previous UL frame. SS1 transmits ranging code i on ranging slot 1, SS2 transmits ranging code j on ranging slot m, and SS3 transmits ranging code k on ranging slot n. After receives all the ranging codes, BS1 then broadcasts an acknowledgement (ACK) back to all the SSs in a subsequent DL frame. The ACK comprises decoding status of all the received ranging slots. If a ranging code is successfully decoded and no physical layer parameters updating is required, then a ranging response (RNG_RSP) is sent back to the corresponding SS indicating that the uplink channel is synchronized and that the SS is able to send subsequent MAC management messages. Otherwise, the SS may retransmit the ranging code until it receives a RNG_RSP from BS1. After sending the RNG_RSPs, BS1 also sends an UL grant to each SS for ranging request (RNG_REQ) messages. Each SS receives the UL grant and transmits a RNG_REQ message to update remaining system parameters (e.g., security context). If the RNG_REQ messages are corrupted, then BS1 may optionally send a NACK back to the SSs. Otherwise, if BS1 replies with a RNG_RSP in response to the RNG_REQ message, then the initial or periodic ranging procedure is successfully completed.

FIG. 11 illustrates a fast feedback mechanism for a failed detection of a ranging code in accordance with the present invention. In the example of FIG. 11, SS1 transmits a ranging code to BS1 and starts a timer in association with the ranging code. BS1 fails to detect the ranging code due to ranging collision. In one novel aspect, a fast feedback status report of previous ranging opportunities is provided to SS1 from BS1 by broadcasting a detection result indicator. Upon reception of the detection result indicator, SS1 can stop its timer and proceed to the next contention (e.g. retransmit the ranging code) immediately if its previous ranging was reported as failed. As a result, SS1 is informed the ranging failure before timer expiration. This prevents SS1 from waiting for the entire timeout period and reduces the overall delay of the contention.

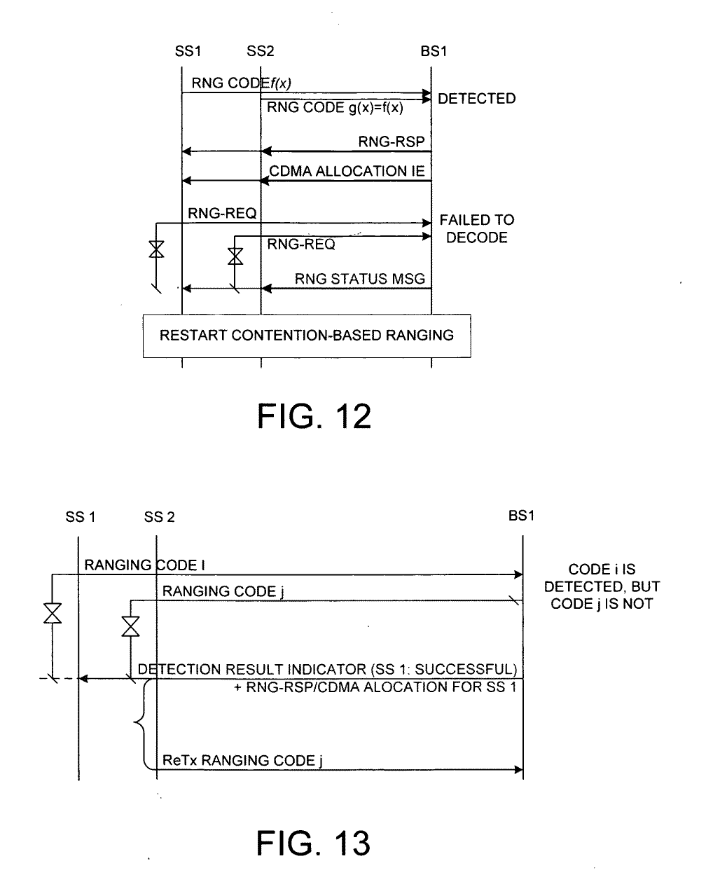

FIG. 12 illustrates a fast feedback mechanism for a detection of collision of ranging request (RNG_REQ) messages in accordance with the present invention. In the example of FIG. 12, SS1 and SS2 simultaneously transmit a ranging code f(x) and g(x) to BS1, respectively. Coincidently, code f(x) is the same as g(x). Upon successfully detects the received ranging code, BS1 broadcasts a ranging response (RNG_RSP) and a CDMA Allocation IE back to SS1 and SS2. SS1 and SS2 then transmit RNG_REQ messages to BS1 simultaneously and start their timers. BS1, however, failed to decode the received RNG_REQ messages due to collision. In one novel aspect, a fast feedback status is provided to SS1 and SS2 from BS1 by broadcasting a ranging status report reporting the RNG_REQ message collision. Upon reception of the ranging status report, SS1 and SS2 can stop their timers and proceed to the next round of contention immediately. As a result, SS1 and SS2 are informed the ranging failure before timer expiration. This prevents SS1 and SS2 from waiting for the entire timeout period and reduces the overall delay of the contention process.

The fast feedback mechanism illustrated above requires the broadcast of an extra ACK/status message from a BS to SSs. Extra overhead is thus introduced by the proposed fast feedback mechanism. Moreover, the extra status message may cause incompatibility with newer SSs and the legacy SSs that do not support fast feedback functionality. These two issues can be effectively avoided by piggybacking the status message in a subsequent downlink broadcast message from the BS to the SSs.

FIG. 13 illustrates a more efficient fast feedback mechanism through piggybacking a ranging response /CDMA Allocation parameters in a detection result indicator IE in accordance with the present invention. As illustrated in FIG. 13, SS1 transmits a ranging code #i on a randomly selected ranging opportunity m to BS1, while SS2 transmits a ranging code #j on a randomly selected ranging opportunity n to BS1 at the same time. BS1 detects ranging code #i in ranging opportunity m, but does not detect ranging code #j in ranging opportunity n. BS1 then broadcasts a detection result indicator IE in a subsequent frame in response to the successful detection of ranging opportunity m and the code index of ranging code #i. In the meantime, a RNG_RSP/CDMA Allocation parameters for SS1 are piggybacked in the IE. The detection result indicator reports failure of ranging opportunity n so SS2 retransmits the ranging code #j without waiting for a full timeout period. By the piggybacking mechanism, no extra message is required during the initial ranging procedure.

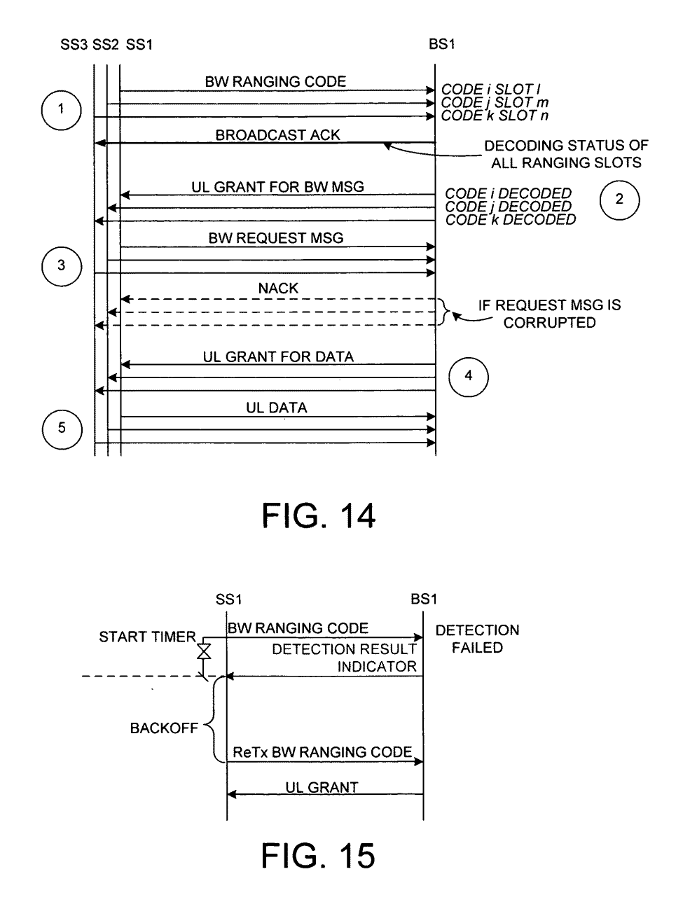

FIG. 14 illustrates a message sequence chart of a bandwidth (BW) request ranging procedure in accordance with one novel aspect. As illustrated in FIG. 14, an IEEE 802.16 compliant wireless system employs a five-step regular BW request ranging procedure. To start a BW request ranging procedure, each SS transmits a randomly selected BW ranging code to BS1 using a randomly selected ranging slot in a previous UL frame (step 1). In the example of FIG. 14, SS1 transmits ranging code i on ranging slot 1, SS2 transmits ranging code j on ranging slot m, and SS3 transmits ranging code k on ranging slot n. After receives all the ranging codes, BS1 then broadcasts an acknowledgement (ACK) back to all the SSs in a subsequent DL frame. The ACK comprises decoding status of all the received ranging slots. If a BW request ranging code is successfully decoded, then an UL grant for BW request message is sent back to the corresponding SS (step 2). After received the UL grant for BW request message, each SS transmits a BW request message to BS1 (step 3). If the BW request messages are corrupted, then BS1 may optionally send a NACK back to the SSs. Otherwise, BS1 transmits an UL grant for data back to the SSs (step 4). The BW request ranging is completed and each SS starts to transmit UL data (step 5).

FIG. 15 illustrates a fast feedback mechanism for a failed detection of a BW request ranging code in accordance with the present invention. As illustrated in FIG. 15, SS1 first transmits a BW request ranging code to BS1 and starts a timer. BS1, however, fails to detect the BW request ranging code transmitted from SS1. In one novel aspect, a fast feedback mechanism is provided by broadcasting a detection result indicator indicating such failed detection. Upon reception of the detection result indicator, SS1 can stop its timer and proceeds to the next round of contention (e.g. retransmit the BW request ranging code) immediately if the previous BW request ranging code was reported failed. Thus SS1 is informed the BW request failure before timer expiration. This prevents SS1 from waiting for the entire timeout time and reduces the overall delay of the contention process.

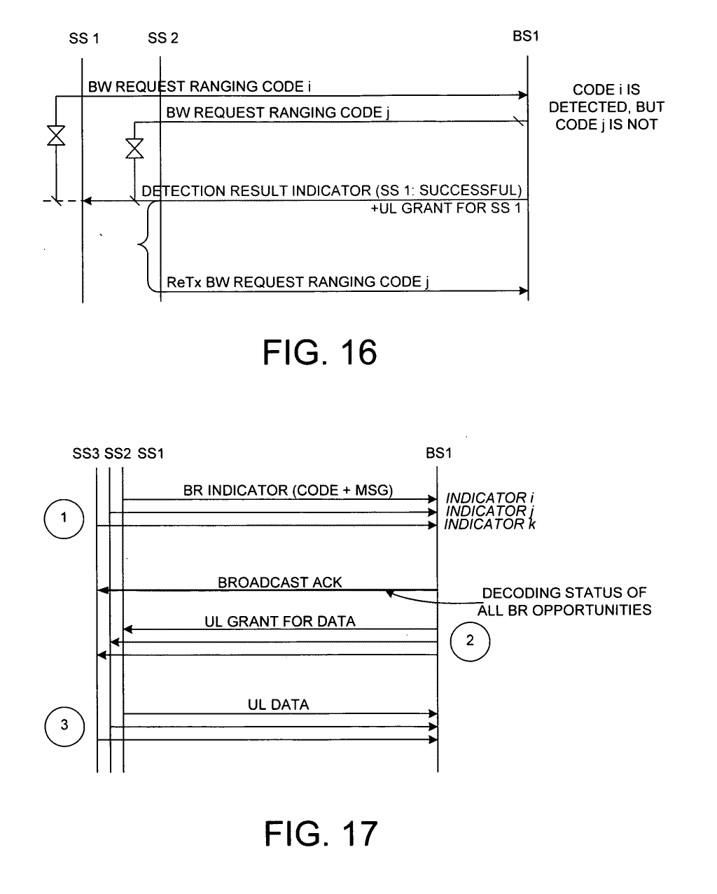

FIG. 16 illustrates a more efficient fast feedback mechanism through piggybacking an UL resource grant in a detection result indicator message in accordance with the present invention. As illustrated in FIG. 16, SS1 transmits a BW request ranging code #i on a randomly selected ranging opportunity m to BS1, while SS2 transmits a BW request ranging code #j on a randomly selected ranging opportunity n to BS1 at the same time. BS1 detects BW_REQ ranging code #i successfully, but fails to detect BW_REQ ranging code #j. BS1 then broadcasts the detection result indicator message in a subsequent frame to indicate the decoding status of the ranging opportunity m and the index of the decoded code (ranging code #i), and the message also carries an UL grant for SS1 in response to the successful detection of BW REQ ranging code #i. Because BW_REQ #j is not successfully detected, the detection result indicator reports the detection failure status of ranging opportunity n. SS2 then retransmits the BW_REQ ranging code #j without waiting for a full timeout period. By piggybacking the subsequent UL grant to the detection result indicator message, no extra message is required during the BW request ranging procedure.

FIG. 17 illustrates a quick access BW request ranging procedure with fast feedback in accordance with a preferred embodiment of the present invention. As illustrated in FIG. 17, an IEEE 802.16m compliant wireless system also employs a three-step quick access BW request ranging procedure. To start a quick access BW request ranging procedure, each SS transmits a randomly selected BW request (BR) indicator to BS1 using a randomly selected BR opportunity (step 1). A BR indicator may include both a BW ranging code and a BW request message. In the example of FIG. 17, SS1 transmits BR indicator #i on BR opportunity 1, SS2 transmits BR indicator #j on BR opportunity m, and SS3 transmits BR indicator #k on BR opportunity n. After receives all the BR indicators, BS1 then broadcasts an acknowledgement (ACK) back to all the SSs. The ACK comprises decoding status of all the received ranging opportunities in the previous frame. If both a BW ranging code and a BW request message are successfully decoded, then an UL grant for data is sent back to the corresponding SS (step 2). After received the UL grant for data, the BW request ranging is completed and each SS starts to transmit UL data (step 3).

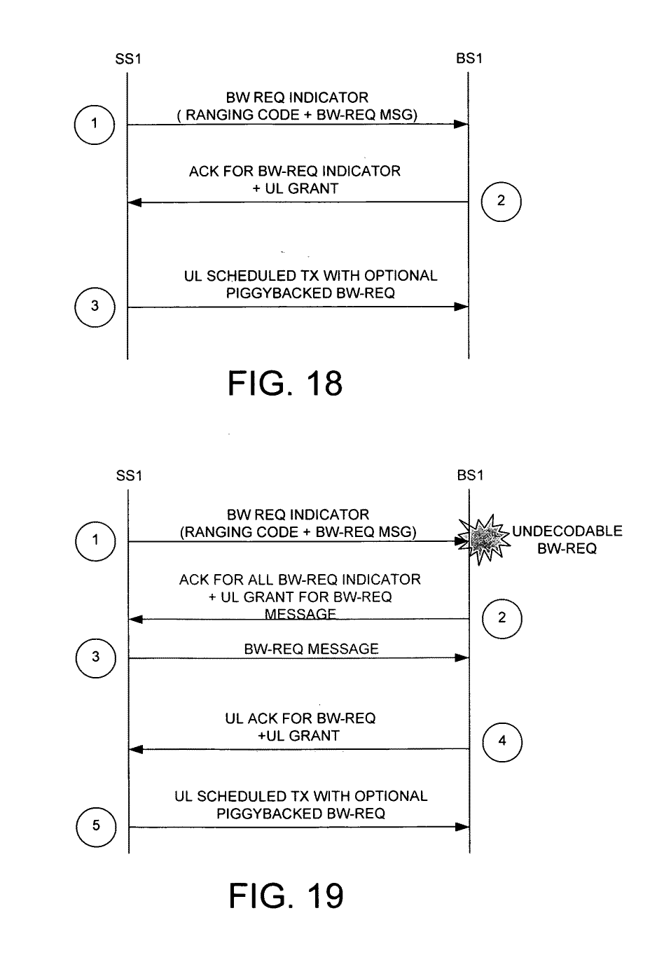

FIG. 18 illustrates a more efficient quick access bandwidth request ranging procedure with fast feedback in accordance with a preferred embodiment of the present invention. As illustrated in FIG. 18, the UL grant is piggybacked in the subsequent ACK message for all BR indicators. Furthermore, when each SS transmits scheduled UL data, additional BW_REQ messages can optionally be piggybacked in the UL data for further bandwidth request.

FIG. 19 illustrates a quick access BW request ranging procedure falling back into a normal 5-step BW request ranging procedure when a BW_REQ message is not decodable in accordance with a preferred embodiment of the present invention. As illustrated in FIG. 19, a BR indicator comprising both a BR ranging code and a BR message is transmitted to BS1 in a previous frame (step 1). BS1, however, is not able to decode the BW REQ message. As a result, BS1 replies ACK to all BR indicators received in the previous frame and an UL grant for SS1 is piggybacked (step 2). SS1 then retransmits a BW_REQ message because of the decoding failure status as reported by the ACK (step 3). In one preferred embodiment, the BS can optionally reply ACK to the BR indicators that are not decoded successfully. BS1 replies ACK to all the BW_REQ messages received in the previous frame and an UL grant for data is piggybacked (step 4). Finally, SS1 transmits its scheduled UL traffic with optionally piggybacked BW_REQ messages (step 5).

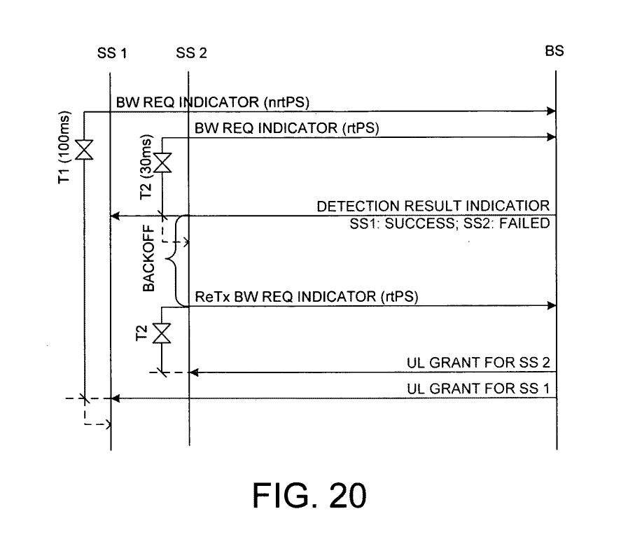

FIG. 20 illustrates a fast feedback bandwidth request ranging procedure with differentiated timers in accordance with a preferred embodiment of the present invention. The fast feedback mechanism set forth above can also be applied to wireless systems that support different types of services. In the example of FIG. 20, SS2 is a preferred subscriber subscribing realtime service while SS1 is a non-realtime service subscriber. Timeout values of ranging timers for SS1 and SS2 are set to 100 ms and 30 ms respectively. First, SS1 transmits a BR indicator with non-realtime polling service (nrtPS) to BS1, and SS2 transmits a BR indicator with realtime polling service (rtPS) to BS1 for quick access. Next, BS1 broadcasts a detection result indicator in response to all the BR indicators received in the previous frame. The detection result indicator indicates that the BR indicator for SS1 is decoded successfully while the BR indicator for SS2 is failed. Because the BR indicator for SS1 is for nrtPS, it is associated with a longer timeout value of 100 ms. On the other hand, the BR indicator for SS2 is for rtPS, it is associated with a shorter timeout value of 30 ms. Upon receiving the detection result indicator, SS2 immediately stops its timer and retransmits the BR indicator to BS1 after a backoff period. In addition, BS1 sends out an UL grant for SS1 and SS2 with a delay up to the associated timeout value. As a result, SS2 receives its UL grant before SS1 for its higher service priority.

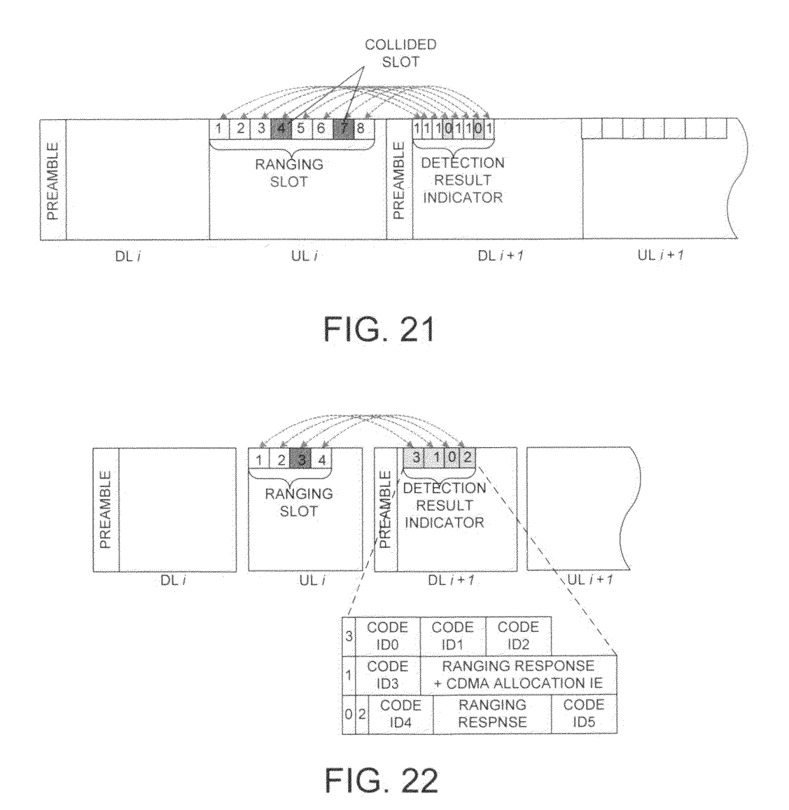

FIG. 21 illustrates a detection result indicator in the form of a bitmap in accordance with a preferred embodiment of the present invention. As illustrated in FIG. 21, eight ranging slots (1-8) are used by SSs for ranging procedure in a previous uplink frame (UL i), while the BS responds with an acknowledgement (ACK) or a detection status indicator in a subsequent downlink frame (DL i+1). The detection status indicator is in a bitmap format having eight bits. Each bit is used to indicate a detection status of a corresponding ranging slot. In the example of FIG. 21, ranging codes on ranging slots #4 and #7 are collided and non-decodable, while ranging codes on all other six ranging slots are successfully decoded. In order to indicate such detection result, the 4^{th} and the 7^{th} bits of the detection result indicator are marked as a digital one, while the other bits of the detection result indicator are marked as a digital zero.

FIG. 22 illustrates another format of a detection result indicator in accordance with a preferred embodiment of the present invention. As illustrated din FIG. 22, four ranging slots (1-4) are used by the SSs for ranging procedure in a previous uplink frame (UL i), while the BS responds with an acknowledgement (ACK) or a detection status indicator in a subsequent downlink frame (DL i+1). The detection result indicator advertises the ranging results for each ranging slot based on the ranging codes received in the previous frame. For slot 1, the message comprises three ranging codes IDs, which indicates the successful decoding of these codes. For slot 2, the message comprises one ranging code ID, which not only advertises the successfully decoded ranging code but also includes additional information such as ranging response and CDMA Allocation IE. For slot 3, none of the ranging code is decoded successfully. For slot 4, the message comprises two ranging codes combined with additional ranging response information.

The above-described fast feedback mechanism for contention-based ranging procedure can be extended to contention-based data transmission. In contention-based data transmission, a base station (BS) grants certain radio resource to be shared among multiple subscriber stations (SSs). For example, the BS grants several data grants to the SSs, and each data grant is a radio resource block to be used by the SSs for data transmission. Without using any bandwidth ranging request procedure, such contention-based data transmission provides fast access for the SSs. When multiple SSs use the same data grant to transmit data, however, the transmitted data by the multiple SSs collides and is no longer decodable.

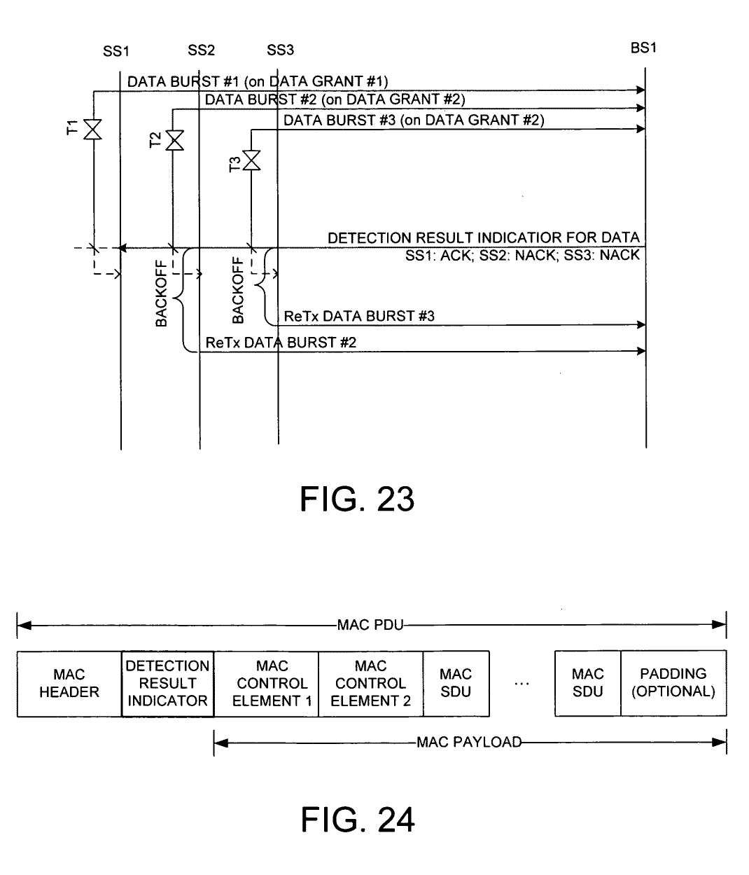

FIG. 23 illustrates a fast feedback contention-based data transmission procedure in accordance with a preferred embodiment of the present invention. As illustrated in FIG. 23, there are three contention users (subscriber stations SS1, SS2, and SS3) and one base station BS1. Each SS first transmits a data burst to BS1 using a randomly selected data grant in a previous UL frame. SS1 transmits data burst #1 on selected data grant #1 and starts timer T1, SS2 transmits data burst #2 on selected data grant #2 and starts timer T2, and SS3 transmits data burst #3 on selected data grant #2 and starts timer T3. After BS1 receives all the data bursts transmitted by the SSs in the previous UL frame, BS1 then broadcasts an acknowledgement (ACK) or a reception status message back to all the SSs in a subsequent DL frame. The ACK is a detection result indicator that indicates reception status of all the data grants in the previous DL frame. If a data burst transmitted using a data grant is successfully decoded, then the ACK indicates that the detection result of the corresponding data grant is successful. Otherwise, if a data burst transmitted using a data grant collides with other data burst and is not decodable, then the ACK indicates that the detection result of the corresponding data grant is failed (NACK). In the example of FIG. 23, data burst #1 transmitted on data grant #1 is successfully decoded, and the broadcasted ACK indicates that the reception result for data grant #1 is successful. On the other hand, data burst #2 and data burst #3 collides with each other and are not decodable because they were transmitted on the same data grant #2. As a result, the broadcasted ACK indicates that the reception status for data grant #2 is failed (NACK). When SS2 receives the NACK indicating failed detection status, it retransmits data burst #2 to BS1 after a backoff period. Similarly, when SS3 receives the NACK indicating failed detection status, it retransmits data burst #3 after a backoff period. Because SS2 and SS3 are able to retransmit data bursts after receiving the NACK without continuing to wait for the entire timeout period, the total latency due to data collision is reduced.

A more efficient fast feedback mechanism for contention-based data transmission is provided through piggybacking the broadcasted detection result indicator. FIG. 24 illustrates a detection result indicator for contention-based data transmission that is piggybacked in a MAC PDU in accordance with the present invention. As illustrated in FIG. 24, when the base station broadcasts to the SSs using a Media Access Control Packet Data Unit (MAC PDU), the detection result indicator is piggybacked or embedded in the MAC PDU. For example, the detection result indicator may be inserted after the MAC header and before the MAC payload. By such piggyback mechanism, no extra message is required during the contention-based data transmission procedure.

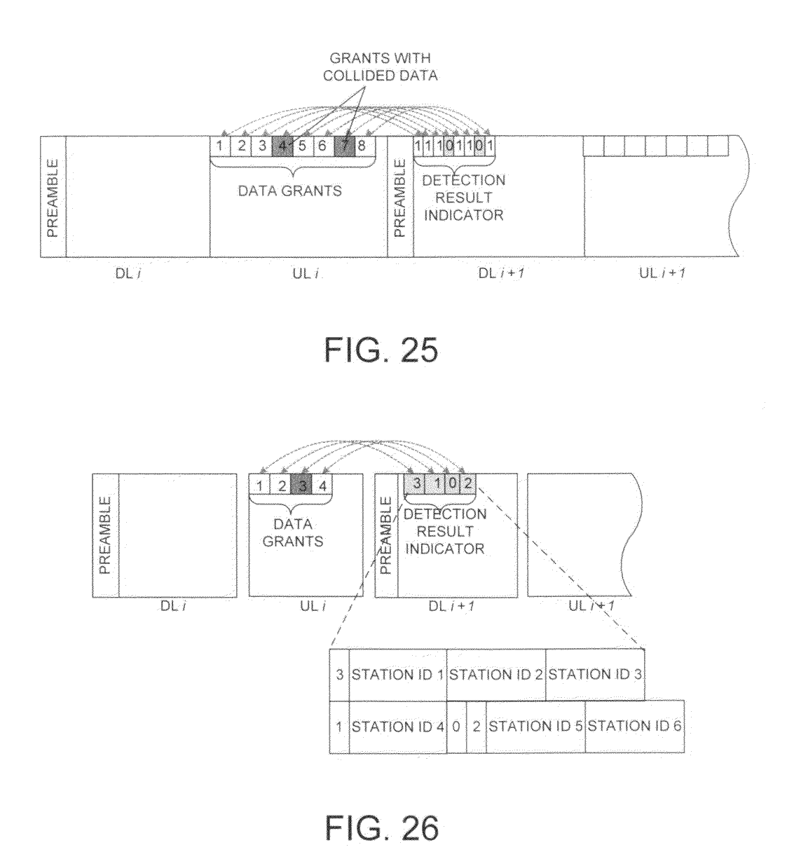

FIG. 25 illustrates a detection result indicator for data in the form of a bitmap in accordance with a preferred embodiment of the present invention. As illustrated in FIG. 25, eight data grants (#1-#8) are used by SSs for contention-based data transmission in a previous uplink frame (UL i), while the BS responds with an acknowledgement (ACK) or a detection result indicator in a subsequent downlink frame (DL i+1). The detection result indicator is in a bitmap format having eight bits. Each bit is used to indicate a reception status of a corresponding data grant. In the example of FIG. 25, data transmitted using data grants #4 and #7 collides and is non-decodable, while data transmitted using other data grants is successfully decoded. In order to indicate such detection result, the 4^{th} and the 7^{th} bits of the detection result indicator are marked as a digital one, while the other bits of the detection result indicator are marked as a digital zero.

FIG. 26 illustrates another format of a detection result indicator for data in accordance with one embodiment of the present invention. As illustrated in FIG. 26, four data grants (#1-#4) are used by the SSs for contention-based data transmission in a previous uplink frame (UL i), while the BS responds with an acknowledgement (ACK) or a reception status message indicating detection results in a subsequent downlink frame (DL i+1). The reception status message advertises the data decoding results as well as station IDs for data transmission based on the data grants received in the previous frame. IN the example of FIG. 26, for data grant #1, the reception status message comprises number three followed by three station IDs of which the transmitted data is successfully decoded. For data grant #2, the reception status message comprises number one followed by one station ID of which the transmitted data is successfully decoded. For data grant #3, the reception status message comprises number zero that indicates no data is decoded successfully. For data grant #4, the reception status message comprises number two followed by two station IDs of which the transmitted data is successfully decoded.

Although the present invention has been described in connection with certain specific embodiments for instructional purposes, the present invention is not limited thereto. CDMA ranging is used as one embodiment of contention-based access protocol. The invention can be extended to other embodiments of contention-based protocols such as certain media access protocol and collision avoidance/collision detection protocol. A Subscriber Station (SS) may include a mobile station (MS), a mobile terminal (MT), and an advanced mobile station (AMS); and a Base Station (BS) may include an advanced base station (ABS). Furthermore, although the embodiments are specifically made for initial ranging and bandwidth request ranging as examples, it is intended to cover other types of ranging procedure in contention based wireless access, such as handover ranging and periodical ranging. Accordingly, various modifications, adaptations, and combinations of various features of the described embodiments can be practiced without departing from the scope of the invention as set forth in the claims.

What is claimed is:

1. A method, comprising:
transmitting a data burst by a mobile station using a data grant in a previous frame, wherein the data grant is selected from a plurality of data grants granted by a base station for contention-based resource access in a wireless communication system; and
receiving an acknowledgement in response to the data grant in a subsequent frame, wherein the acknowledgement is broadcasted by the base station indicating reception status of the plurality of data grants of the previous frame.

2. The method of claim 1, wherein the data grant is a contention-based resource grant comprising a radio resource block to be shared among multiple mobile stations.

3. The method of claim 1, wherein the acknowledgement comprises a detection result indicator having a plurality of bits, and wherein a reception status of the data grant is indicated by one of the plurality of bits that corresponds to the data grant.

4. The method of claim 3, wherein the acknowledgement further comprises information of the mobile station that corresponds to the data grant.

5. The method of claim 1, further comprising:
starting a timer associated with the transmission of the data burst; and
retransmitting the data burst without expiration of the timer if the acknowledgement indicates a decoding failure of the data grant.

6. The method of claim 1, wherein the acknowledgement is piggybacked in a Media Access Control Packet Data Unit (MAC PDU) transmitted by the base station.

7. A method, comprising:
receiving a data burst transmitted by a mobile station in a previous frame using a data grant, wherein the data grant is selected from a plurality of data grants granted by a base station for contention-based resource access in a wireless communication system; and
broadcasting an acknowledgement by the base station in a subsequent frame, wherein the acknowledgement indicates reception status of the plurality of data grants of the previous frame.

8. The method of claim 7, wherein the data grant is a contention-based resource grant comprising a radio resource block to be shared among multiple mobile stations.

9. The method of claim 7, wherein the acknowledgement comprises a detection result indicator having a plurality of bits, and wherein a reception status of the selected data grant is indicated by one of the plurality of bits that corresponds to the selected data grant.

10. The method of claim 9, wherein the acknowledgement further comprises information of the mobile station that corresponds to the selected data grant.

11. The method of claim 7, further comprising:
receiving the data burst retransmitted by the mobile station when the acknowledgement indicates a decoding failure of the selected data grant.

12. The method of claim 7, wherein the acknowledgement is piggybacked in a Media Access Control Packet Data Unit (MAC PDU) transmitted by the base station.

13. A wireless communication system, comprising:
a mobile station that transmits a data burst using a data grant in a previous frame, wherein the data grant is selected from a plurality of data grants granted for contention-based resource access in a wireless communication system; and
a base station that receives the data burst and in response broadcasts an acknowledgement in a subsequence frame, wherein the acknowledgement indicates reception status of the plurality of data grants of the previous frame.

14. The system of claim 13, wherein the data grant is a contention-based resource grant comprising a radio resource block to be shared among multiple mobile stations.

15. The system of claim 13, wherein the acknowledgement comprises a detection result indicator having a plurality of bits, and wherein a reception status of the selected data grant is indicated by one of the plurality of bits that corresponds to the selected data grant.

16. The system of claim 15, wherein the acknowledgement further comprises information of the mobile station that corresponds to the selected data grant.

17. The system of claim 13, wherein the mobile station starts a timer associated with the transmission of the data burst, and wherein the mobile station retransmits the data burst without expiration of the timer if the broadcasted acknowledgement indicates a decoding failure of the selected data grant.

18. The system of claim 13, wherein the acknowledgement is piggybacked in a Media Access Control Packet Data Unit (MAC PDU) transmitted by the base station.
